(19) United States
(12) Patent Application Publication
(10) Pub. No.: US 2017/0005751 A1
(43) Pub. Date: Jan. 5, 2017

(54) TRANSFER DEVICE AND DATA PROCESSING METHOD

(71) Applicant: FUJITSU LIMITED, Kawasaki-shi (JP)

(72) Inventor: Hiroyuki Kitajima, Oyama (JP)

(73) Assignee: FUJITSU LIMITED, Kawasaki-shi (JP)

(21) Appl. No.: 15/180,150

(22) Filed: Jun. 13, 2016

(30) Foreign Application Priority Data
Jul. 2, 2015 (JP) 2015-133786

(51) Int. Cl. H04L 1/00; H04B 10/40

(52) U.S. Cl. CPC H04L 1/0041; H04L 1/0045; H04B 10/40

(57) ABSTRACT

A transfer device includes: a plurality of calculators configured to perform an encoding operation on split input data obtained by splitting input data in a specific unit in parallel; a plurality of storages configured to store respective results of the encoding operation; and a generator configured to add the results of the encoding operation stored in the plurality of storages and generate an error correcting code to be added to the input data.

### CROSS-REFERENCE TO RELATED APPLICATION

This application is based upon and claims the benefit of priority of the prior Japanese Patent Application No. 2015-133786, filed on Jul. 2, 2015, the entire contents of which are incorporated herein by reference.

### FIELD

The embodiment discussed herein relates to a transfer device and a data processing method.

### BACKGROUND

A transfer standard called the optical transport network (OTN) is prescribed in the G.709 of the International Telecommunication Union Telecommunication Standardization Sector (ITU-T) as a method for effectively transferring signals over a transmission line in an optical transfer network. The OTN frame format includes forward error correction (FEC) in which the Reed-Solomon (255, 239) code (written below as “RS (255, 239)”) is used, for example, for correcting errors in order to improve the quality of long-distance transmission.

A transfer device in the optical transfer network computes the FEC in conformance with the ITU-T G.709. In the case of the RS (255, 239), the transfer device adds a 16-symbol FEC to the input data of 239 symbols with 1 symbol equaling 8 bits. Error correction is carried out up to a maximum of 8 symbols in the RS (255,239).

Related techniques are disclosed in Japanese Laid-open Patent Publication No. 10-041830 and Japanese Laid-open Patent Publication No. 11-136136.

### SUMMARY

According to an aspect of the invention, a transfer device includes: a plurality of calculators configured to perform an encoding operation on split input data obtained by splitting input data in a specific unit in parallel; a plurality of storages configured to store respective results of the encoding operation; and a generator configured to add the results of the encoding operation stored in the plurality of storages and generate an error correcting code to be added to the input data.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of a transfer system;

FIG. 2 illustrates an example of an OTN frame format;

FIG. 3 illustrates an example of an element list table;

FIG. 4 illustrates an example of an FEC encoding unit;

FIG. 5 illustrates an example of an FEC encoding unit;

FIGS. 6A to 6C illustrate an example of a division processing using generator polynomials; and

FIG. 7 illustrates an example of an FEC generating processing.

### DESCRIPTION OF EMBODIMENT

In processing to generate FECs to be added to input data, a processing result from the rear stage of a clock timing that is an operation clock for FEC generation is incorporated at the front stage of a next clock timing. In this case, a timing error may occur due to signal delays in each stage of the FEC generation. In order to avoid timing errors, the amount of data to be processed in one clock is increased and the operation clock is reduced to lengthen the clock cycle. In this case, FEC generation is carried out in parallel in a plurality of circuits in order to increase the amount of data to be processed in one clock. The processing result from the rear stage of the clock timing that is the operation clock for FEC generation is incorporated at the front stage of the next clock timing in the lengthened clock cycle.

When carrying out FEC generation in parallel with a plurality of circuits, the processing result of the rear stage of the FEC generation is incorporated at the front stage. As a result, when the processing result of the rear stage of the FEC generation is incorporated at the front stage, the number of stages of the FEC generation is increased in order to carry out the FEC generation with the plurality of circuits and timing errors may occur due to signal delays in each stage of the FEC generation.

In the following explanation, the explanation of overlapping or similar configurations or processing may be omitted. The following embodiment is not intended to limit the techniques disclosed herein. The embodiment may be combined as appropriate within a consistent scope.

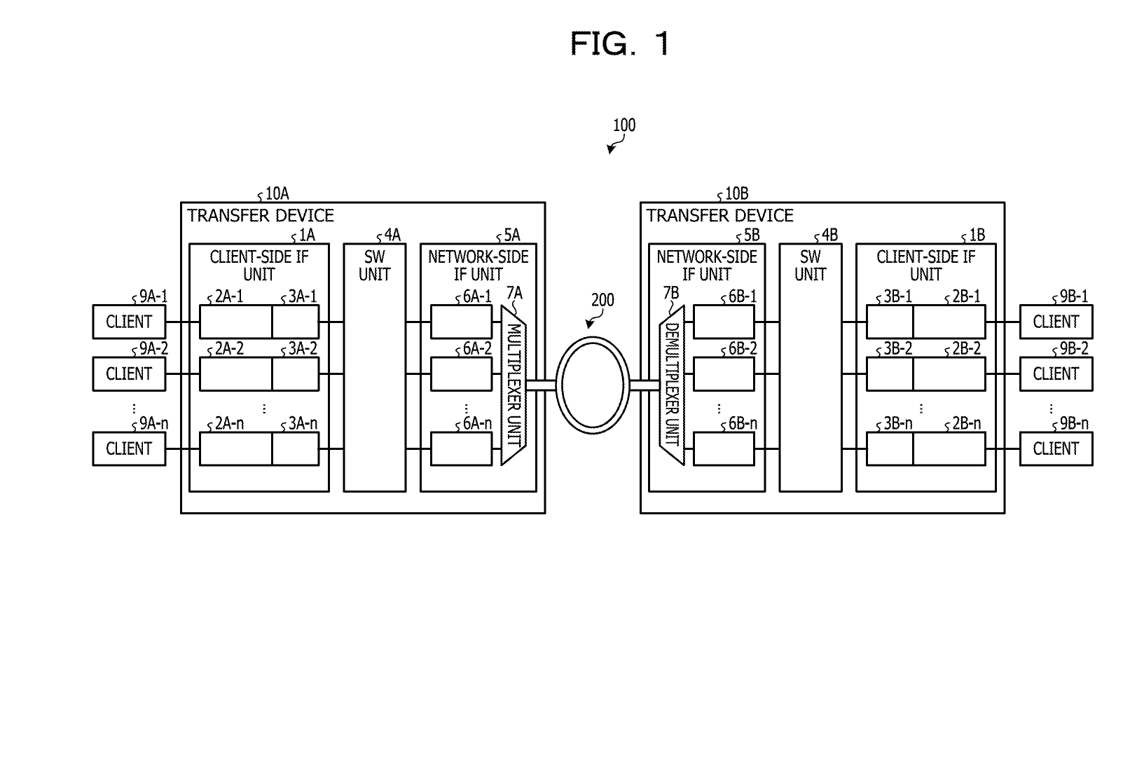

FIG. 1 illustrates an example of a transfer system. As illustrated in FIG. 1, a transfer system 100 has a transfer device 10A and a transfer device 10B that are coupled via a network 200. The transfer system 100 may be an optical transport network (OTN) for example. In FIG. 1, the transfer device 10A is the transmission side and the transfer device 10B is the reception side. However, the transfer device 10A and the transfer device 10B may be either the transmission side or the reception side.

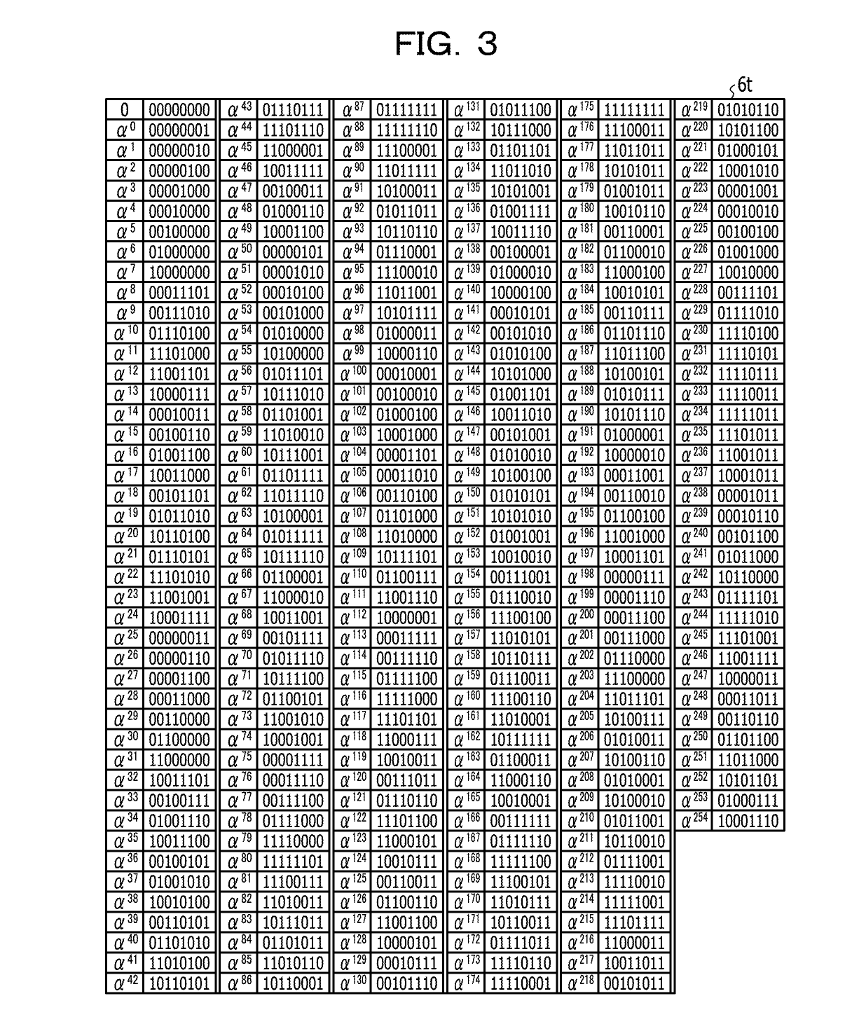

The transfer device 10A has a client-side interface (IF) unit 1A, a switch (SW) unit 4A, and a network-side IF unit 5A. The client-side IF unit 1A has mapping units 2A-1 to 2A-n and overhead (OH) inserting units 3A-1 to 3A-n. Here, n represents a natural number. The network-side IF unit 5A has FEC encoding units 6A-1 to 6A-n, and a multiplexer unit 7A. The FEC encoding units 6A-1 to 6A-n hold an element list table 6t (see FIG. 3).

The mapping units 2A-1 to 2A-n and the overhead (OH) inserting units 3A-1 to 3A-n are respectively coupled to clients 9A-1 to 9A-n. The mapping units 2A-1 to 2A-n map user data from the respective clients 9A-1 to 9A-n to payload regions in OTN frames. The OH inserting units 3A-1 to 3A-n insert overheads into the OTN frames subjected to the mapping into the payload regions by the respective mapping units 2A-1 to 2A-n.

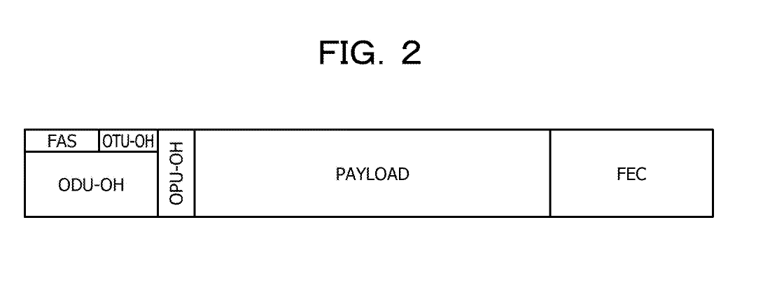

FIG. 2 illustrates an example of an OTN frame format. As illustrated in FIG. 2, the OTN frame format includes a frame alignment signal (FAS), an OTU-OH, an optical channel data unit (ODU)-OH, an optical channel payload unit (OPU)-OH, a payload, and a forward error correction (FEC). FAS is an abbreviation for frame alignment signal. The OH inserting units 3A-1 to 3A-n insert each of the overheads, the OTU-OH, the ODU-OH, and the OPU-OH, into the OTN frame.

The SW unit 4A inputs the OTN frames output by the OH inserting units 3A-1 to 3A-n into any of the FEC encoding units 6A-1 to 6A-n of the network-side IF unit 5A through path switching. The FEC encoding units 6A-1 to 6A-n generate forward error correction (FEC) codes based on Reed-Solomon of RS (255, 239), for example, and add the codes to the inputted OTN frames. The multiplexer unit 7A multiplexes the OTN frames provided with the FECs from the FEC encoding units 6A-1 to 6A-n and transmits the frames to the network 200. The FEC encoding units 6A-1 to 6A-n may include a field-programmable gate array (FPGA) or an application specific integrated circuit (ASIC) for example.

The transfer device 10B has a network-side IF unit 5B, a SW unit 4B, and a client-side IF unit 1B. The network-side IF unit 5B has a demultiplexer unit 7B and FEC decoding units 6B-1 to 6B-n. The client-side IF unit 1B has OH terminating units 3B-1 to 3B-n, and demapping units 2B-1 to 2B-n. Each of the OH terminating units 3B-1 to 3B-n and the demapping units 2B-1 to 2B-n are respectively coupled to clients 9B-1 to 9B-n.

The demultiplexer unit 7B inputs each of OTN frames in which signals received from the network 200 are demultiplexed into the respective FEC decoding units 6B-1 to 6B-n. The FEC decoding units 6B-1 to 6B-n carry out error correcting of the OTN frames based on, for example, the Reed-Solomon forward error correcting (FEC) code RS (255, 239) added to the input OTN frames. Error correcting using the FECs may be called decoding. The FEC encoding units 6B-1 to 6B-n hold the element list table 6t (see FIG. 3). The FEC decoding units 6B-1 to 6B-n may include an FPGA or an ASIC for example.

The SW unit 4B inputs the OTN frames input from the FEC decoding units 6B-1 to 6B-n into any of the OH terminating units 3B-1 to 3B-n of the client-side IF unit 1B through path switching. The OH terminating units 3B-1 to 3B-n remove the OTU-OH, ODU-OH, and OPU-OH overheads from the input OTN frames. The demapping units 2B-1 to 2B-n demap the user data from the payload region of the OTN frames in which the overheads were removed by the OH terminating units 3B-1 to 3B-n, and transmits the user data to the clients 9B-1 to 9B-n.

In FEC operations, signals are handled as Reed-Solomon symbols defined according to a Galois field GF (2⁸). The Galois field GF (2⁸) is a finite field where 2⁸ =256 elements exist. The primitive polynomial expression of the Galois field GF (2⁸) includes x⁸+x⁴+x³+x²+1. When one primitive element of the Galois field GF (2⁸) is assumed to be α, the power of a becomes all of the elements of the Galois field GF (2⁸). αⁱ (0≦i≦254) is calculated from the primitive polynomial expression x⁸+x⁴+x³+x²+1 by using the relationship α⁸+α⁴+α³+α²+1 =0 or α⁸ =α⁴+α³+α²+1. When “0” is further added to αⁱ (0≦i≦254), all of the elements in the Galois field GF (2⁸) expressed by 8 bits are generated as indicated in FIG. 3. FIG. 3 illustrates an example of an element list table. The FEC operation may be handled as the addition or division of the elements in the Galois field GF (2⁸).

Addition in the Galois field GF (2⁸) is defined by considering each digit in a binary expression of the elements in the Galois field GF (2⁸) as the components of a vector and by adding the components in a Galois field GF (2). For example, addition is defined as Exclusive-OR (Ex-OR) for each bit in the binary expressions of the elements in the Galois field GF (2⁸). For example, α³ =(00001000), α⁵ =(00100000), and (00001000)+(00100000)=(00101000)=α⁵³ when referring to FIG. 3.

Multiplication in the Galois field GF (2⁸) is defined by adding the exponents (indexes) of the elements in the Galois field GF (2⁸) with a remainder (mod255) when divided by 255 (2⁸−1). For example, α¹²³×α²³¹=α^{(123+231)mod255}=α⁹⁹ when referring to FIG. 3.

In this way, the FEC encoding units 6A-1 to 6A-n divide the input data with generator polynomials and insert the remainders thereof in the FEC region.

The FEC decoding units 6B-1 to 6B-n carry out syndrome arithmetic (division through generator polynomials) on the received data and calculate equations for specifying error positions based on the results thereof. The equations are simultaneous equations and therefore the values and the positions where the errors occur can be understood by solving the simultaneous equations. The data resulting from carrying out error correction processing on the data made to wait for the series of operations, is output.

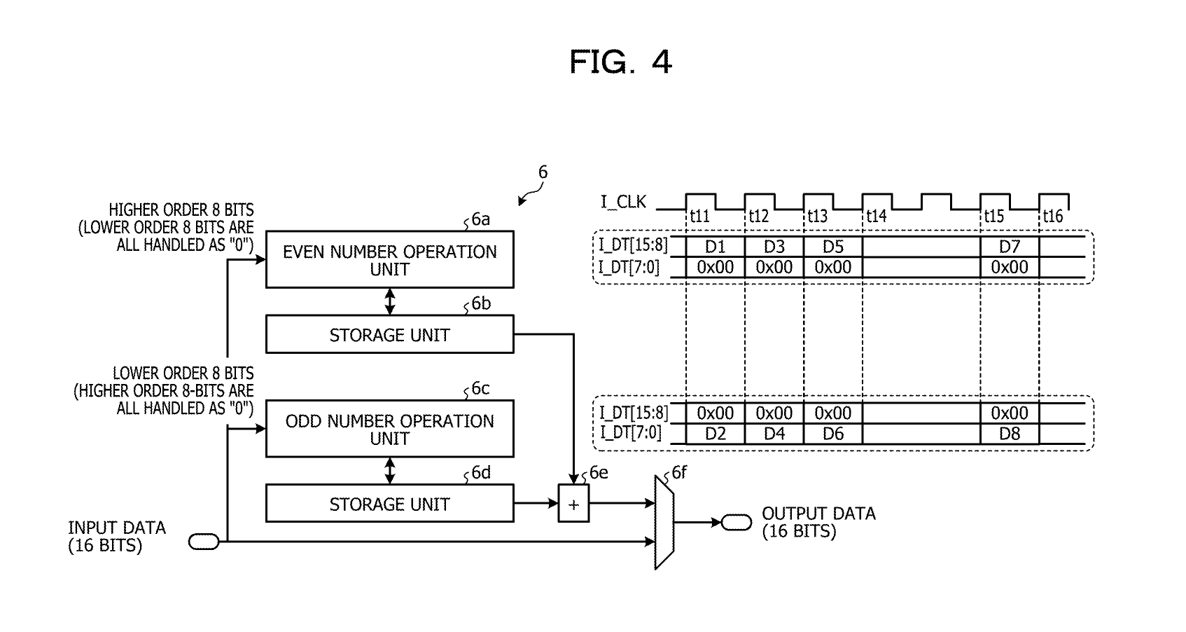

FIG. 4 illustrates an example of an FEC encoding unit. In FIG. 4, the n in FIG. 1 is assumed to be n=2. Hereinbelow, the FEC encoding units 6A-1 to 6A-2 may be referred to as FEC encoding unit 6. The FEC encoding unit 6 splits the input data into units where 1 symbol=8 bits, and respectively divides the two symbols for each of the two surrounding symbols in separate circuits with a certain generator polynomial, to calculate each remainder. The FEC encoding unit 6 finally generates the FECs to be added to the input data by adding the remainders. For example, when two parallel processes are being carried out, the FEC encoding unit 6 generates the FECS by splitting the input data into even numbers and odd numbers, dividing the respective split data by the certain generator polynomial, and adding each of the remainders. The addition of the remainders is carried out by Ex-OR for each bit. Hereinbelow, the process for dividing the input data with the certain generator polynomial and calculating the remainders may be referred to as encoding.

As illustrated in FIG. 4, the FEC encoding unit 6 has an even number operation unit 6a, a storage unit 6b, an odd number operation unit 6c, a storage unit 6d, and adder 6e, and a selector 6f. The FEC encoding unit 6 operates according to a certain clock I-CLK (for example, 300 MHz). The storage units 6b and 6d may be flip-flop (FF) units.

The even number operation unit 6a carries out the encoding operation based on the operation results from the immediately preceding clock stored in the storage unit 6b, and from first data of 16 bits which includes higher order 8 bits and lower order 8 bits all of which are set as “0” from among the 16-bit input data of the current clock, and stores the operation results in the storage unit 6b. The odd number operation unit 6c carries out the encoding operation based on the operation results from the immediately preceding clock stored in the storage unit 6d, and from second data of 16 bits which includes higher order 8 bits and lower order 8 bits all of which are set as “0” from among the 16-bit input data of the current clock, and stores the operation results in the storage unit 6d. The FEC encoding unit 6 adds each of the operation results stored in the storage unit 6b and 6d with the adder 6e when generating the output data. The selector 6f switches and sequentially outputs the input data and the FECs which are the addition results from the adder 6e so that the FECs are added to the input data in the rear stage.

For example, as illustrated in FIG. 4, the even number operation unit 6a sets I_DT[15:8] which is the higher order 8-bit data as “D1” and sets all of I_DT[7:0] which is the lower order 8-bit data as “0x00” among the 16-bit input data I_DT[15:0] when carrying out the 16-bit data encoding during timing t11 to t12 of the clock I_CLK. At the same time, the odd number operation unit 6c sets all of I_DT[15:8] which is the higher order 8-bit data as “0x00” and sets I_DT[7:0] which is the lower order 8-bit data as “D2” among the 16-bit input data I_DT[15:0] when carrying out the 16-bit data encoding during the timing t11 to t12 of the clock I_CLK. Similarly, the even number operation unit 6a and the odd number operation unit 6c carry out encoding in parallel for all of the clock I_CLK timings from t12 to t13 up to t15 to t16. The 16-bit input data I_DT[15:0] is input data before the FECs are added and is input for each one symbol per one clock of the certain clock I-CLK.

For example, the input data I_DT[15:0] for each one clock of the certain clock I-CLK is divided by a generator polynomial in the even number operation unit 6a or the odd number operation unit 6c that includes a multiplier and an adder for FEC operations, among the input data I_DT subject to the FEC addition. The division results (remainders) are held in the storage units 6b and 6d at the point in time when all of the input data I_DT subject to the FEC addition is input. The adder 6e generates the FECs to be added to the data subject to the FEC addition by adding the division results held in the storage units 6b and 6d. The I_DT and the outputs of the adder 6e are selected by the selector 6f whereby the data to which the FECs have been added to the output data O_DT is output.

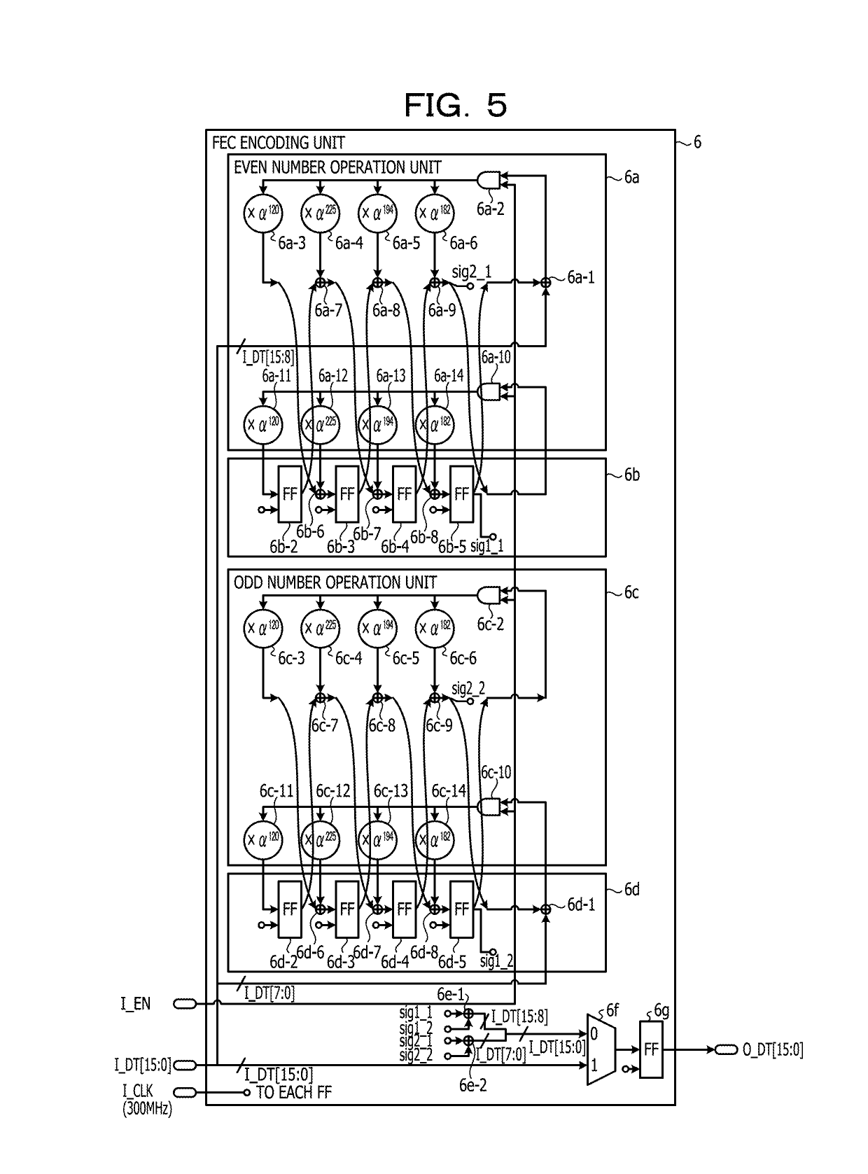

FIG. 5 illustrates an example of an FEC encoding unit. FIG. 5 is a detailed view of FIG. 4. In FIG. 5, the generator polynomial for dividing the input data is indicated as x⁴+α¹⁸²x³+α¹⁹⁴x²+α²²⁵x+α¹²⁰ with the primitive element being a. A clock of, for example, 300 MHz is supplied as the I_CLK to each FF. As illustrated in FIG. 5, the FEC encoding unit 6 has the even number operation unit 6a, the storage unit 6b, the odd number operation unit 6c, the storage unit 6d, and adders 6e-1 and 6e-2, the selector 6f, and a flip-flop (FF) 6g.

The even number operation unit 6a has an adder 6a-1 and an AND gate 6a-2. The even number operation unit 6a has multipliers 6a-3 to 6a-6. The even number operation unit 6a has adders 6a-7 to 6a-9. The even number operation unit 6a has an AND gate 6a-10. Furthermore, the even number operation unit 6a has multipliers 6a-11 to 6a-14.

The storage unit 6b has FFs 6b-2 to 6b-5. The storage unit 6b has adders 6b-6 to 6b-8.

The odd number operation unit 6c has an AND gate 6c-2. The odd number operation unit 6c has multipliers 6c-3 to 6c-6. The odd number operation unit 6c has adders 6c-7 to 6c-9. The odd number operation unit 6c has an AND gate 6c-10. The odd number operation unit 6c has multipliers 6c-11 to 6c-14.

The storage unit 6b has the FFs 6b-2 to 6b-5 and the adders 6b-6 to 6b-8. The storage unit 6d has FFs 6d-2 to 6d-5 and adders 6d-1 and 6d-6 to 6d-8.

The adder 6a-1 outputs, to the AND gate 6a-2, the addition result of adding the I_DT[15:8] which is the higher order 8 bits of the 16-bit input data I_DT[15:0] to the output of the FF 6b-5. The I_DT[15:8] which is the higher order 8 bits of the 16-bit input data I_DT[15:0] is an element of the 8-bit Galois field GF (2⁸) and may correspond to the data of the even number positions. The AND gate 6a-2 takes the logical product of the input from the adder 6a-1 and an enable signal I_EN and outputs the logical product to the multipliers 6a-3 to 6a-6. The enable signal I_EN indicates the input data region with “H”, indicates the FEC region with “L” and is used for controlling the selection of the input data I_DT[15:0] and the FEC operation result.

The multiplier 6a-3 outputs the multiplication result from the input from the AND gate 6a-2 and α¹²⁰ =(00111011) to the adder 6b-6. The multiplier 6a-4 outputs the multiplication result from the input from the AND gate 6a-2 and α²²⁵=(00100100) to the adder 6a-7. The adder 6a-7 outputs the addition result from the input from the FF 6b-2 and the input from the multiplier 6a-4 to the adder 6b-7.

The multiplier 6a-5 outputs the multiplication result from the input from the AND gate 6a-2 and α¹⁹⁴=(00110010) to the adder 6a-8. The adder 6a-8 outputs the addition result from the input from the FF 6b-3 and the input from the multiplier 6a-5 to the adder 6b-8.

The multiplier 6a-6 outputs the multiplication result from the input from the AND gate 6a-2 and α¹⁸²=(01100010) to the adder 6a-9. The adder 6a-9 outputs the addition result from the input from the FF 6b-4 and the input from the multiplier 6a-6 to the AND gate 6a-10 and the adder 6e-2.

The AND gate 6a-10 takes the logical product of the input from the adder 6a-9 and an enable signal I_EN and outputs the logical product to the multipliers 6a-11 to 6a-14.

The multiplier 6a-11 outputs the multiplication result from the input from the AND gate 6a-10 and α¹²⁰=(00111011) to the FF 6b-2. The multiplier 6a-12 outputs the multiplication result from the input from the AND gate 6a-10 and α²²⁵=(00100100) to the adder 6b-6. The adder 6b-6 outputs the addition result from the input from the multiplier 6a-3 and the input from the multiplier 6a-12 to the FF 6b-3.

The multiplier 6a-13 outputs the multiplication result from the input from the AND gate 6a-10 and α¹⁹⁴=(00110010) to the adder 6b-7. The adder 6b-7 outputs the addition result from the input from the adder 6a-7 and the input from the multiplier 6a-13 to the FF 6b-4.

The multiplier 6a-14 outputs the multiplication result from the input from the AND gate 6a-10 and α¹⁸²=(01100010) to the adder 6b-8. The adder 6b-8 outputs the addition result from the input from the adder 6a-8 and the input from the multiplier 6a-14 to the FF 6b-5. The FF 6b-5 outputs the information to be stored to the adder 6e-1.

The AND gate 6c-2 takes the logical product of the input from the FF 6d-5 and the enable signal I_EN and outputs the logical product to the multipliers 6c-3 to 6c-6.

The multiplier 6c-3 outputs the multiplication result from the input from the AND gate 6c-2 and α¹²⁰=(00111011) to the adder 6d-6. The multiplier 6c-4 outputs the multiplication result from the input from the AND gate 6c-2 and α²²⁵=(00100100) to the adder 6c-7. The adder 6c-7 outputs the addition result from the input from the FF 6d-2 and the input from the multiplier 6c-4 to the adder 6d-7.

The multiplier 6c-5 outputs the multiplication result from the input from the AND gate 6c-2 and α¹⁹⁴=(00110010) to the adder 6c-8. The adder 6c-8 outputs the addition result from the input from the FF 6d-3 and the input from the multiplier 6c-5 to the adder 6d-8.

The multiplier 6c-6 outputs the multiplication result from the input from the AND gate 6c-2 and α¹⁸²=(01100010) to the adder 6c-9. The adder 6c-9 outputs the addition result from the input from the FF 6d-4 and the input from the multiplier 6c-6 to the adder 6d-1 and the adder 6e-2.

The adder 6d-1 outputs, to the AND gate 6c-10, the addition result of adding the I_DT[7:0] which is the lower order 8 bits of the 16-bit input data I_DT[15:0] to the output of the adder 6c-9. The I_DT[7:0] which is the lower order 8 bits of the 16-bit input data I_DT[15:0] is an element of the 8-bit Galois field GF (2⁸) and may correspond to the data of the odd number positions. The AND gate 6c-10 takes the logical product of the input from the adder 6d-1 and the enable signal LEN and outputs the logical product to the multipliers 6c-11 to 6c-14.

The multiplier 6c-11 outputs the multiplication result from the input from the AND gate 6c-10 and α¹²⁰=(00111011) to the FF 6d-2. The multiplier 6c-12 outputs the multiplication result from the input from the AND gate 6c-10 and α²²⁵=(00100100) to the adder 6d-6. The adder 6d-6 outputs the addition result from the input from the multiplier 6c-3 and the input from the multiplier 6c-12 to the FF 6d-3.

The multiplier 6c-13 outputs the multiplication result from the input from the AND gate 6c-10 and α¹⁹⁴=(00110010) to the adder 6d-7. The adder 6d-7 outputs the addition result from the input from the adder 6c-7 and the input from the multiplier 6c-13 to the FF 6d-4.

The multiplier 6c-14 outputs the multiplication result from the input from the AND gate 6c-10 and α¹⁸²=(01100010) to the adder 6d-8. The adder 6d-8 outputs the addition result from the input from the adder 6c-8 and the input from the multiplier 6c-14 to the FF 6d-5. The FF 6d-5 outputs the information to be stored to the adder 6e-1.

The adder 6e-1 outputs the addition result from the input from the FF 6b-5 and the input from the FF 6d-5 to the selector 6f. The adder 6e-2 outputs the addition result from the input from the adder 6a-9 and the input from the adder 6d-9 to the selector 6f.

The selector 6f switches the input from the adder 6e-1 or 6e-2 with the input data I_DT[15:0] and outputs the result sequentially to the FF 6g. The FF 6g outputs output data O_DT[15:0] in which the FEC that is the remainder derived by dividing the input data I_DT[15:0] by the generator polynomial is added to the input data I_DT[15:0].

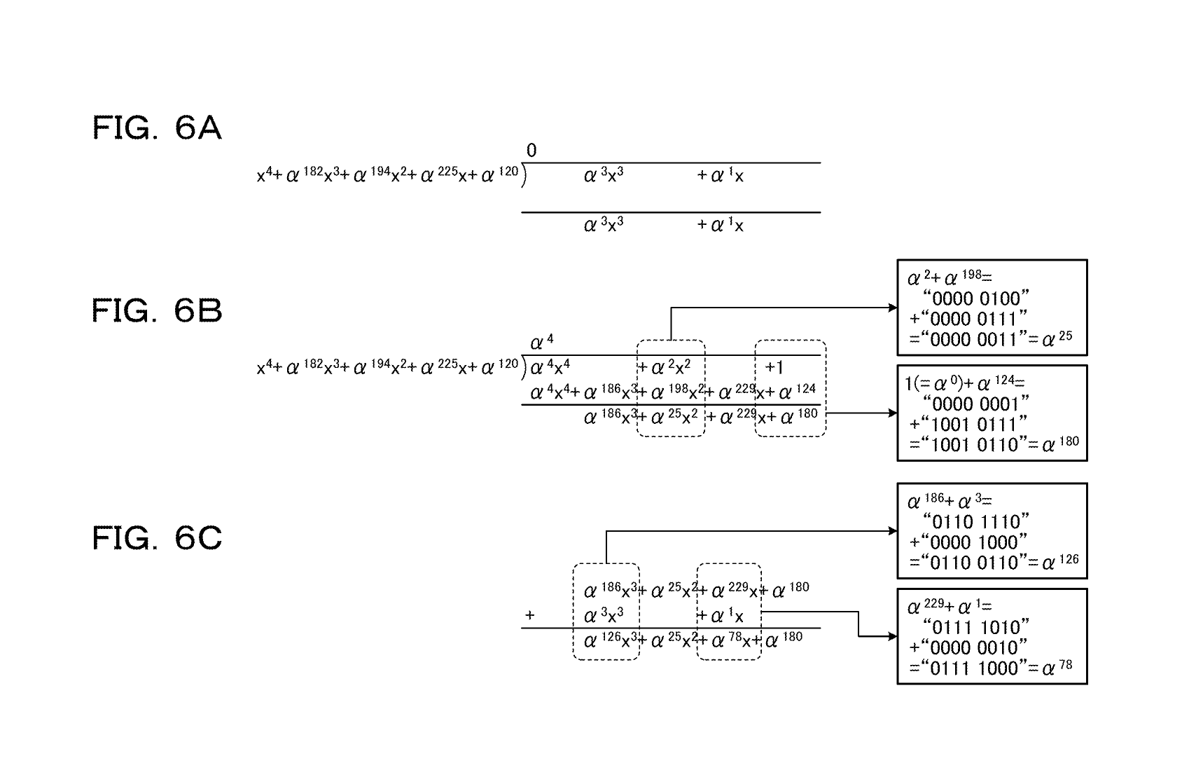

FIGS. 6A to 6C illustrate an example of a division processing using generated polynomials. FIGS. 6A to 6C illustrate the processing by the FEC encoding unit 6 depicted in FIG. 5 in greater detail. The input data is five symbols of (α⁴, α³, α², α¹, α⁰) and the input sequence is α⁰, α¹, α², α³, α⁴ in 16-bit units. The generator polynomial is x⁴+α¹⁸²x³+α¹⁹⁴x²+α²²⁵x+α¹²⁰.

For example in FIGS. 6A to 6C, α⁴x⁴+α³x³+α²x²+α¹x+α⁰ is split into a polynomial expression made up of odd number position members and a polynomial expression made up of even number position members, and the remainders derived by dividing each of the polynomial expressions by the generator polynomial are totaled. As a result, the remainders resulting from dividing α⁴x⁴+α³x³+α²x²+α¹x+α⁰ with the generator polynomial are derived.

FIG. 6A illustrates processing based on even numbered division which is, for example, processing by the even number operation unit 6a in the FEC encoding unit 6. The polynomial expression for the even number members of the input data is α³x³+α¹x. As illustrated in FIG. 6A, when α³x³+α¹x is divided by x⁴+α¹⁸²x³+α¹⁹⁴x²+α²²⁵x+α¹²⁰, the remainder is α³x³+α¹x.

FIG. 6B illustrates processing based on odd numbered division, for example, processing by the odd number operation unit 6c in the FEC encoding unit 6. The polynomial expression for the odd number members of the input data is α⁴x⁴+α²x²+1. As illustrated in FIG. 6B, when α⁴x⁴+α²x²+1 is divided by x⁴+α¹⁸²x³+α¹⁹⁴x²+α²²⁵x+α¹²⁰, the remainder is α¹⁸⁶x³+α²⁵x²+α²²⁹x+α¹⁸⁰ from the element list table 6t of the Galois field GF (2⁸) in FIG. 3.

As illustrated in FIG. 6C, the addition of the remainders which is, for example, the addition of the remainders based on each of the even number terms and the odd number terms, is carried out. When the remainders are totaled, the result is α¹²⁶x³+α²⁵x²+α⁷⁸x+α¹⁸⁰ based on the element list table 6t of the Galois field GF (2⁸) in FIG. 3. The result α¹²⁶x³+α²⁵x² +α⁷⁸x+α¹⁸⁰ is the remainder when α⁴x⁴+α³x³+α²x²+α¹x+α⁰ is divided by the generator polynomial x⁴+α¹⁸²x³+α¹⁹⁴x²+α²²⁵x+α¹²⁰, and yields the FEC of α⁴x⁴+α³x³+α²x²_{+α}¹x+α⁰.

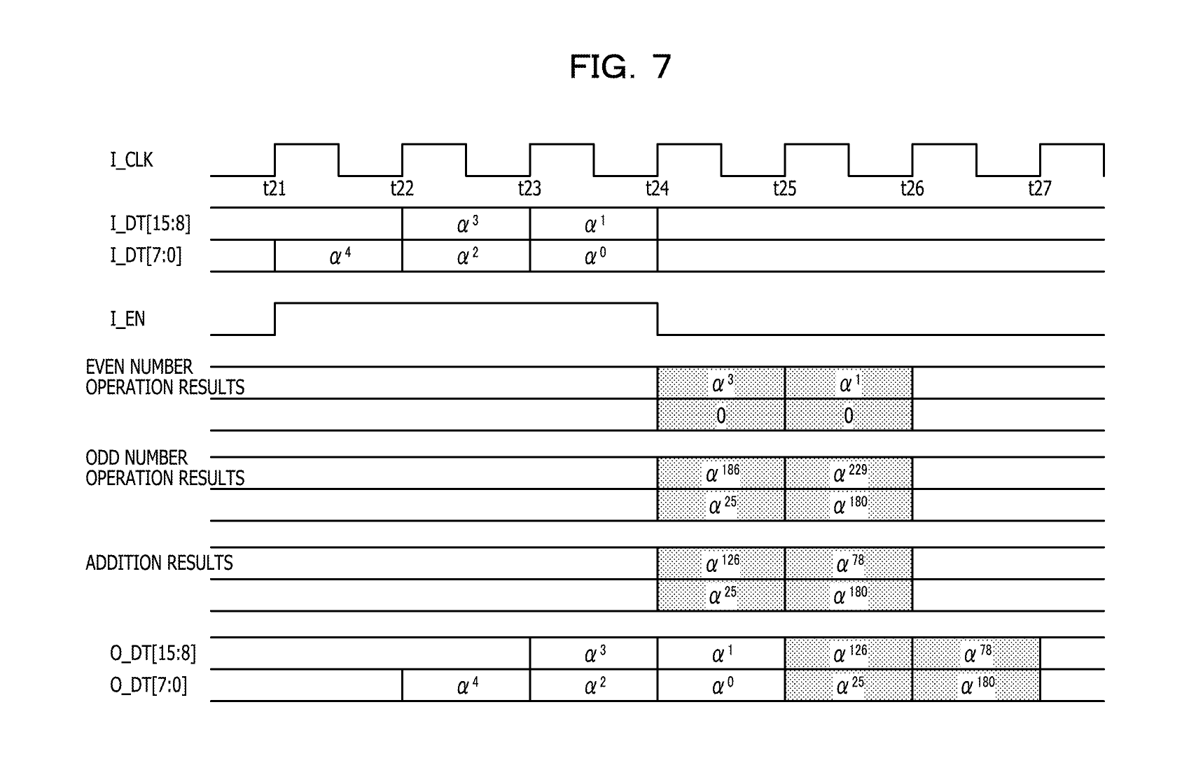

FIG. 7 illustrates an example of an FEC generating processing. FIG. 7 illustrates a time chart of the division using the generator polynomial depicted in FIGS. 6A to 6C. As illustrated in FIG. 7, the odd number operation unit 6c calculates, during timing t24 to t26, the remainder derived by dividing, by the generator polynomial, the polynomial expression made up of the odd-order members that are coefficients of the odd number position data among the input data inputted during timing t21 to t24. The even number operation unit 6a calculates, during timing t24 to t26, the remainder derived by dividing, by the generator polynomial, the polynomial expression made up of the even-order members that are coefficients of the even number position data among the input data inputted during timing t21 to t24 in parallel with the processing by the odd number operation unit 6c. The division results from the even number operation unit 6a and the odd number operation unit 6c during timing t24 to t26 are added whereby the FEC to be added to the input data during the timing t25 to t27 is calculated.

Similar to the encoding for the FEC generation in FIGS. 4 to 7, the syndrome operations may be carried out by the FEC decoding units 6B-1 to 6B-n.

The encoding for computing the forward error correcting (FEC) codes in the Reed-Solomon method during transmission of OTN frames is encoding by splitting even number position symbols and odd number position symbols among different circuits. As a result, the data transfer speed is increased and the FECs which are forward error correcting codes in the Reed-Solomon method are added to the OTN frames without the occurrence of data delays even when the circuit operation clocks do not follow the data transfer speed. Because encoding without causing data delays can be carried out even when using inexpensive devices that do not have the level of performance desired to follow the data transfer speed, the component costs may be reduced.

For example, one symbol equals eight bits and the input data to receive the FECs inputted in 2-symbol units is split into 1-symbol units. A polynomial expression made up of odd-order members using odd number position symbols as coefficients and a polynomial expression made up of even-order members using even number position symbols as coefficients are generated. Two operation units made up of the odd-number operation unit that divides the polynomial expression made up of the odd-order members with the generator polynomial and the even-number operation unit that divides the polynomial expression made up of the even-order members with the generator polynomial derive the respective remainders concurrently. The FEC to be added to the input data is generated by adding the remainders.

For example, assuming that N is a natural integer of 2 or greater, the input data to receive the FEC inputted in units of N-symbols is split into 1-symbol units. N number of polynomial expressions made up of members of each i-order using, as coefficients, the congruent symbols in which the input sequence i (where i is a natural number) in symbol units have N as the modulo. Remainders are derived in parallel in the N-number of operation units that divide each of the N-number of polynomial expressions with the generator polynomial. The FECs to be added to the input data may be generated by adding the remainders. An example in which N equals 2 is depicted in the above embodiment.

For example, if N equals 3, the input data of five symbols (for example, α⁰, α¹, α², α³, α⁴ which are inputted in this order as data units of (α⁰, α^{l}, α²), (α³, α⁴)) to be added to the FECs inputted in 3-symbol units is split into 1-symbol units. Three polynomial expressions (for example, α²x², α⁴x⁴+α¹x¹, α³x³+α⁰) are generated made up of each degree using, as a coefficient, the congruent symbols in which the input sequence for each symbol unit has 3 as the modulo. α²x² is a polynomial expression made up of members of the order of the remainder 2 with the modulo 3. α⁴x⁴+α¹x¹ is the polynomial expression made up of the members of the coset of the remainder 1 using the modulo 3. α³x³+α¹x¹ is the polynomial expression made up of the members of the order of the remainder 0 using the modulo 3. For example, a first operation unit calculates a first remainder by dividing α²x² by the generator polynomial. For example, a second operation unit calculates a second remainder by dividing α⁴x⁴+α¹x¹ by the generator polynomial. For example, a third operation unit calculates a third remainder by dividing α³x³+α⁰ by the generator polynomial. The result of adding the first to third remainders yields the derived FEC.

The FEC encoding units 6A-1 to 6A-n may be provided in the network-side IF unit 5A of the transfer device 10A on the transmission side. Moreover, the FEC decoding units 6B-1 to 6B-n may be provided in the network-side IF unit 5B of the transfer device 10B on the receiving side. The FEC encoding units and the FEC decoding units may be provided in any of the client-side IF unit 1A and the network-side IF unit 5A in the transfer device 10A of the transmission side, or the client-side IF unit 1B and the network-side IF unit 5B of the transfer device 10B on the receiving side.

The transfer system 100 may be an OTN which carries out data transmission with OTN frames. The transfer system 100 may carry out data transmission with frames from WiMAX (trademark) which is a broadband wireless communication standard conforming to IEEE 802.16 or with frames from DVB (trademark)-x which is a digital television broadcasting standard. The transfer system 100 may carry out data transmission with frames of a broadband wireless access network standard based on the European Telecommunications Standards Institute-Broadband Radio Access Network (ETSI-BRAN), or with frames of the Consultative Committee for Space Data Systems (CCSDS) which is a space data system.

All of or a portion of the constituent elements in each of the illustrated devices may be functionally or physically distributed or integrated in arbitrary units in accordance with the various loads or usage conditions and the like.

All of or arbitrary portions of the various functional processes carried out by the devices may be executed by a central processing unit (CPU). All of or arbitrary portions of the various processing functions carried out by the devices may be executed by a network processor (NP), a microprocessing unit (MPU), a microcontroller unit (MCU), or by a microcomputer such as an ASIC or a FPGA. All of or arbitrary portions of the various processing functions may also be executed on a program that executes analysis with a CPU (or a microcomputer such as an MPU or MCU), or on hardware based on wired logic. For example, a program executed by a CPU or a microcomputer may be stored in a memory.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A transfer device comprising:
a plurality of calculators configured to perform an encoding operation on split input data obtained by splitting input data in a specific unit in parallel;
a plurality of storages configured to store respective results of the encoding operation; and
a generator configured to add the results of the encoding operation stored in the plurality of storages and generate an error correcting code to be added to the input data.

2. The transfer device according to claim 1, wherein:
the input data is input with a plurality of symbol units, split into 1-symbol units each corresponding to the specific unit, and supplied to the plurality of calculators.

3. The transfer device according to claim 1, wherein:
the plurality of calculators includes a first calculator and a second calculator; and
the first calculator calculates a first remainder by dividing a first polynomial expression including odd-order members having an odd number position symbol as a coefficient among a first symbol of the input data, by a generator polynomial; and
the second calculator calculates a second remainder by dividing a second polynomial expression including even-order members having an even number position symbol as a coefficient among the first symbol, by the generator polynomial.

4. The transfer device according to claim 3, wherein:
the generator is configured to generate the error correction code by adding the first remainder and the second remainder.

5. The transfer device according to claim 3, wherein:
the plurality of storages includes a first storage and a second storage; and
the first storage is configured to store the first remainder,
the second storage is configured to store the second remainder, and
the generator is configured to generate the error correction code by adding the first remainder stored in the first storage and the second remainder stored in the second storage.

6. A transfer device comprising:
a plurality of calculators configured to carry out a syndrome operation on split input data obtained by splitting input data in a specific unit in parallel;
a plurality of storages configured to store respective results of the syndrome operation; and
an error corrector configured to carry out an error correction on the input data based on a sum of the results of the syndrome operation stored in the plurality of storages, and an error correcting code added to the input data.

7. The transfer device according to claim 6, wherein:
the input data is input with a plurality of symbol units, split into 1-symbol units each corresponding to the specific unit, and supplied to the plurality of calculators.

8. The transfer device according to claim 6, wherein:
the plurality of calculators include a first calculator and a second calculator; and
the first calculator calculates a first remainder by dividing a first polynomial expression including odd-order members having an odd number position symbol as a coefficient among a first symbol of the input data, by a generator polynomial; and
the second calculator calculates a second remainder by dividing a second polynomial expression including even-order members having an even number position symbol as a coefficient among the first symbol, by the generator polynomial.

9. The transfer device according to claim 8, wherein:
the error corrector is configured to carry out the error correction based on the error correcting code and a sum of the first remainder and the second remainder.

10. The transfer device according to claim 8, wherein:
the plurality of storage includes a first storage and a second storage; and
the first storage is configured to store the first remainder,
the second storage is configured to store the second remainder, and
the error corrector is configured to carry out the error correction based on the error correcting code and a sum of the first remainder stored in the first storage and the second remainder stored in the second storage.

11. A data processing method, comprising:
carrying out, by a plurality of calculators, an encoding operation or a syndrome operation in parallel on split input data obtained by splitting input data in a specific unit;
storing respective results of an operation of the plurality of calculators in a corresponding storage among a plurality of storages;
adding, when the encoding operation is carried out, the results of the encoding operation stored in the plurality of storages and generating an error correcting code to be added to the input data; and
carrying out, when the syndrome operation is carried out, an error correction on the input data based on a sum of the results of the syndrome operation stored in the plurality of storages, and an error correcting code added to the input data.

12. The data processing method according to claim 11, wherein:
the input data is input with a plurality of symbol units, split into 1-symbol units each corresponding to the specific unit, and supplied to the plurality of calculators.

13. The data processing method according to claim 11, wherein:
the plurality of calculators includes a first calculator and a second calculator; and
the first calculator calculates a first remainder by dividing a first polynomial expression including odd-order members having an odd number position symbol as a coefficient among a first symbol of the input data, by a generator polynomial; and
the second calculator calculates a second remainder by dividing a second polynomial expression including even-order members having an even number position symbol as a coefficient among the first symbol, by the generator polynomial.

14. The data processing method according to claim 13, wherein:
the error correction code is generated by adding the first remainder and the second remainder when the syndrome operation is carried out.

15. The data processing method according to claim 13, wherein:
the error correction is carried out based on the error correcting code and a sum of the first remainder and the second remainder when the syndrome operation is carried out.
